(19) United States
(12) Patent Application Publication
(10) Pub. No.: US 2015/0159837 A1
(43) Pub. Date: Jun. 11, 2015

(54) ILLUMINATION ASSEMBLY

(71) Applicant: Chi Lin Optoelectronics Co., Ltd, Tainan City (TW)

(72) Inventors: Yi-Hsuan TAl, Tainan City (TW); Ming-Hsien WU, Tainan City (TW); Pao-Yuan HSU, Tainan City (TW)

(21) Appl. No.: 14/566,771

(22) Filed: Dec. 11, 2014

(30) Foreign Application Priority Data
Dec. 11, 2013 (TW) 102223375
Mar. 19, 2014 (TW) 103204690

(51) Int. Cl. F21V 11/00

(52) U.S. Cl. CPC F21V 11/00; F21Y 2101/02

(57) ABSTRACT

An illumination assembly and a display panel are provided. The illumination assembly has an optical plate, a pattern layer, and a light source. The optical plate is made of transparent material and has a surface and at least one side connected to the surface. The pattern layer is disposed on the surface and having a plurality of microstructures. The light source is disposed adjacent to the optical plate.

### FIELD OF THE INVENTION

The present invention relates to an illumination assembly, and more particularly to an illumination assembly which has a pattern layer.

### BACKGROUND OF THE INVENTION

Referring now to FIG. 1, a traditional LCD module is illustrated. As shown, the LCD module 10 has a first optical plate 11, a second optical plate 12 and liquid crystal 13. The liquid crystal 13 is disposed between the first optical plate 11 and the second optical plate 12.

The second optical plate 12 further has a plurality of electrodes 121. An orientation of the liquid crystal 13 can be controlled by regulating the voltage of the electrodes 121 so that the light transmission of the second optical plate 12 can be adjusted, and the second optical plate 12 can be shielded or penetrated.

However, the manufacture of the LCD module 10 is complex and costly. As a result, it is necessary to provide an illumination assembly to solve the problems existing in the conventional technologies.

### SUMMARY OF THE INVENTION

An object of the present invention is to provide an illumination assembly wherein the substantial 3D imaging effect and the tactility of rough surface can be generated by laterally connecting and/or stacking a plurality of inkjet printed structures.

To achieve the above object, the present invention provides an illumination assembly which comprises an optical plate, a pattern layer, and a light source. The optical plate is made of transparent material and has a surface and at least one side connected to the surface. The pattern layer is disposed on the surface and has a plurality of microstructures. The light source is disposed adjacent to the optical plate.

In one embodiment of the present invention, the light source is an LED or a lamp, and is disposed adjacent to and corresponding to the side of the optical plate.

In one embodiment of the present invention, the illumination assembly further comprises an interface layer disposed between the pattern layer and the surface of the optical plate, and a surface tension of the interface layer is less than that of the surface.

In one embodiment of the present invention, the microstructures are inkjet printed structures.

In one embodiment of the present invention, the inkjet printed structures are laterally connected to each other, so as to form a broad structural area.

In one embodiment of the present invention, the inkjet printed structures are stacked with each other, so as to form a stacked structural area.

In one embodiment of the present invention, the inkjet printed structures comprise at least one first inkjet printed structure and at least one second inkjet printed structure, a width of the first inkjet printed structure is greater than that of the second inkjet printed structure, and the difference therebetween is more than 10 um.

In one embodiment of the present invention, the illumination assembly is installed in a light frame, a drawing frame, or a window frame.

In one embodiment of the present invention, the illumination assembly is a visible plate when the light source does not emit light, and the illumination assembly is a shielding plate when the light source emits light.

To achieve the above object, the present invention further provides an illumination assembly which comprises an optical plate, a pattern layer, and a light source. The optical plate has a first surface and a second surface opposite the first surface. The pattern layer is disposed on the second surface and has a plurality of microstructures. The light source is disposed adjacent to the optical plate and emits light into the optical plate, wherein the light are further emitted out of the optical plate from the first surface. The optical plate is used as a shielding plate if the optical plate is viewed from the first surface, and the optical plate is used as a visible plate if the optical plate is viewed from the second surface.

In one embodiment of the present invention, the optical plate further comprises a side between the first surface and the second surface, and the light source faces the side.

In one embodiment of the present invention, the microstructures are protruded from or recessed in the second surface.

In one embodiment of the present invention, the microstructures are inkjet printed structures, screen printed structures, or laser engraved structures.

In one embodiment of the present invention, a ratio of the height to the diameter of each of the microstructures is ranged from 1/7 to ⅓.

In one embodiment of the present invention, the second surface has a first area, and a ratio of a total projected area of the microstructures disposed within the first area to a total area of the first area is ranged from 0.15 to 0.5.

In one embodiment of the present invention, the illumination assembly is disposed in a compartment.

In one embodiment of the present invention, the first surface faces outside of the compartment, and the second surface faces inside of the compartment.

In one embodiment of the present invention, the compartment is a bedroom, a conference room, or a bathroom.

In one embodiment of the present invention, a ratio of the light extraction efficiency of the light emitted out of the first surface to that of the light emitted out of the second surface is ranged from 1.2 to 19.

In one embodiment of the present invention, the illumination assembly further comprises a panel, and the panel is disposed adjacent to the optical plate, wherein the panel has at least one rough surface, and the light passes through the rough surface to generate substantial 3D images corresponding to the pattern layer.

The pattern of the present invention can be produced by disposing the inkjet printed structures. The substantial 3D imaging effect and the tactility of rough surface can be generated by laterally connecting and/or stacking the inkjet printed structures. The higher the distribution density of the inkjet printed structures is, and the better the shielding effect of the inkjet printed structures generated by laterally connecting and/or stacking the inkjet printed structures will be.

### DESCRIPTION OF THE DRAWINGS

FIG. 1 is a schematic view of a traditional LCD module;

FIG. 2A is a side view of an illumination assembly according to an embodiment of the present invention;

FIG. 2B is a side view of an illumination assembly according to another embodiment of the present invention;

FIG. 3A is a top view of inkjet printed structures according to another embodiment of the present invention;

FIG. 3B is a side view of inkjet printed structures according to another embodiment of the present invention;

FIG. 3C is a top view of inkjet printed structures according to another embodiment of the present invention;

FIG. 3D is a top view of inkjet printed structures according to another embodiment of the present invention;

FIG. 4 is a schematic view of an illumination assembly installed in a light frame according to another embodiment of the present invention;

FIG. 5 is a schematic view of an illumination assembly installed in a drawing frame according to another embodiment of the present invention;

FIG. 6A is a schematic view of an illumination assembly according to an embodiment of the present invention when the light source does not emit light;

FIG. 6B is a schematic view of an illumination assembly according to an embodiment of the present invention when the light source emits light;

FIG. 7 is a schematic view of an illumination assembly installed in a window frame according to another embodiment of the present invention;

FIG. 8A is a side view of an illumination assembly according to another embodiment of the present invention;

FIG. 8B is a partial view of an area (a) from FIG. 8A;

FIG. 8C is a side view of an illumination assembly according to another embodiment of the present invention;

FIG. 8D is a side view of an illumination assembly according to another embodiment of the present invention;

FIG. 9 is a side view of an optical plate according to another embodiment of the present invention;

FIGS. 10A to 10B are schematic views of an optical plate disposed on the second surface from FIG. 8A;

FIGS. 11A to 11B are schematic views of an illumination assembly used as a shielding plate or a visible plate according to another embodiment of the present invention; and

FIG. 12 is a schematic view of an illumination assembly disposed in a compartment.

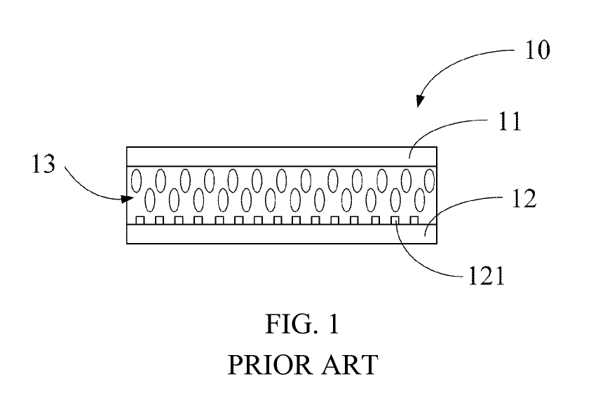

### DETAILED DESCRIPTION OF THE PREFERRED EMBODIMENTS

The structure and the technical means adopted by the present invention to achieve the above and other objects can be best understood by referring to the following detailed description of the preferred embodiments and the accompanying drawings. Furthermore, directional terms described by the present invention, such as upper, lower, front, back, left, right, inner, outer, side, longitudinal/vertical, transverse/horizontal, etc., are only directions by referring to the accompanying drawings, and thus the used directional terms are used to describe and understand the present invention, but the present invention is not limited thereto.

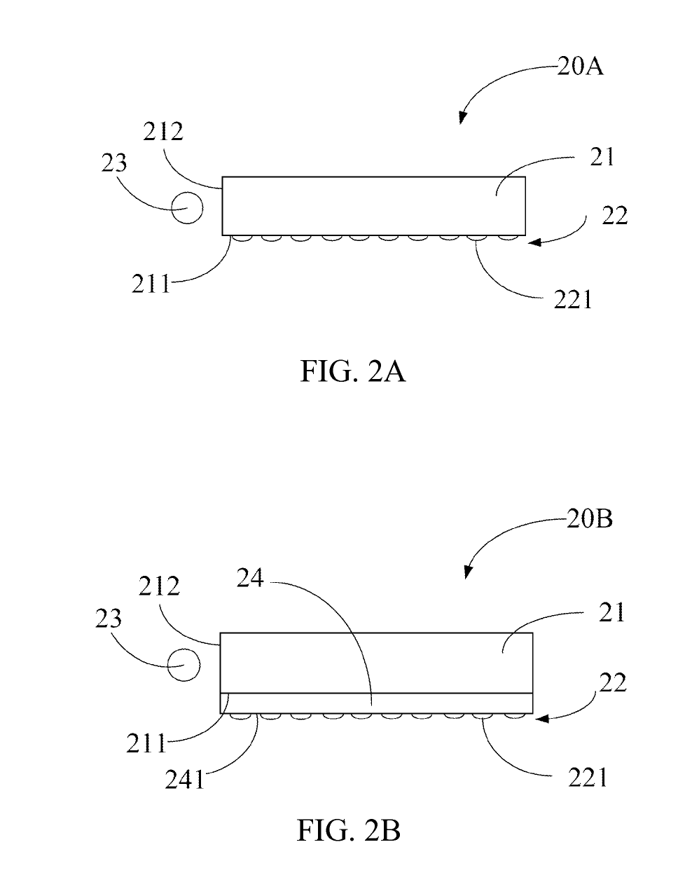

Refer to FIG. 2A, which shows a side view of an illumination assembly according to an embodiment of the present invention. The illumination assembly 20A comprises an optical plate 21, a pattern layer 22, and a light source 23. The pattern layer 21 has a surface 211 and at least one side 212 connected to the surface 211. The pattern layer 22 is disposed on the surface 211. The light source 23 is disposed adjacent to the optical plate 21 corresponding to the side 212 of the optical plate 21. The optical plate 21 is made of transparent material which can be poly methyl methacrylate (PMMA), polycarbonate (PC), cyclic olefin copolymer (COC), polystyrene (PS), or glass, but the transparent material is not limited thereto. The light source 23 is one or more light emitting diode (LED) or Cold Cathode Fluorescent Lamp (CCFL).

In the embodiment of the present invention, the pattern layer 22 has a plurality of microstructures which are inkjet printed structures 221. The inkjet printed structures 221 are directly formed by printing liquid inks or glue, or indirectly formed by firstly printing inks or glue and then by illuminating ultraviolet (UV) light or Infrared (IR) light, heating, cooling and embossing etc., but the forming method of the inkjet printed structures 221 is not limited thereto.

If the shape of each inkjet printed structures 221 is more arched, the light extraction and the light reflex will be better. A surface tension of the inkjet printed structures 221 can be changed by adjusting the composition of the printed inks and glue, so as to form an arched shape. But, the arched shape can also be formed by the following way. Refer to FIG. 2B, which shows a side view of an illumination assembly according to another embodiment of the present invention. An illumination assembly according to FIG. 2B is illustrated and similar to the illumination assembly according to FIG. 2A. As shown, the illumination assembly 20B further comprises an interface layer 24 disposed between the pattern layer 22 and the surface 211 of the optical plate 21, and a surface tension of a surface 241 of the interface layer 24 is less than that of the surface 211 of the optical plate 21. Thus, when the inkjet printed structures 221 are formed on the surface 241 of the interface layer 24, the inkjet printed structures 221 will form an arched shape because the surface tension of a surface 241 of the interface layer 24 is relatively low. The interface layer 24 is made of acrylic material (such as methyl methacrylate and a surface modifier). Any material which has relatively lower surface tension can be used as the interface layer 24, and thus the material thereof is not limited to the acrylic material.

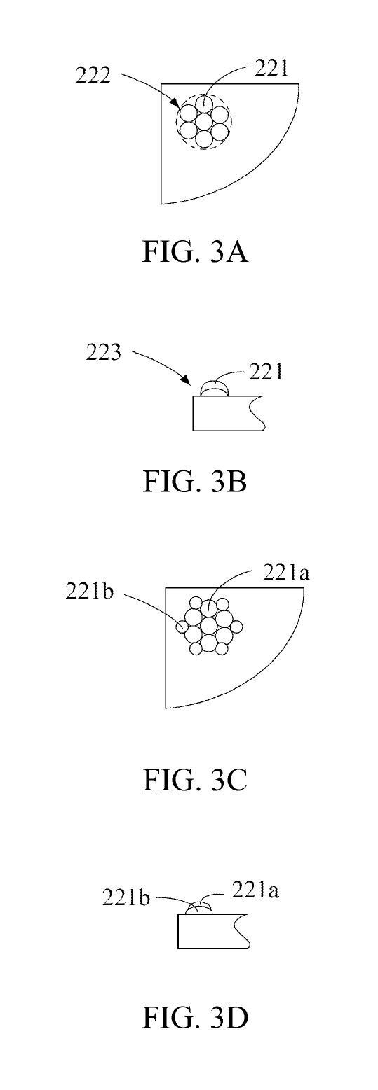

The pattern layer of the present invention can be formed by setting the distribution density of a plurality of inkjet printed structures 221, and can also be formed by the following way. Refer to FIG. 3A, which shows a top view of inkjet printed structures according to another embodiment of the present invention. A plurality of inkjet printed structures 221 of the embodiment are made by continuous printing, wherein the inkjet printed structures 221 are laterally connected to each other, so as to form a broad structural area 222. A width of the broad structural area 222 is flexible by adjusting the lateral connection. Preferably, the width is ranged from 90 μm to 1,000 μm, or more than 1,000 μm.

Refer to FIG. 3B, which shows a top view of inkjet printed structures according to another embodiment of the present invention. Additional inkjet printed structures 221 are further printed again in the same area after firstly printing and solidifying the inkjet printed structures 221. Two layers of the inkjet printed structures 221 are stacked with each other, so as to form a stacked structural area 223. The stacked structural area 223 can be stacked in two layers, three layers, four layers, or more. A height of the stacked structural area 223 is flexible by adjusting the number of stacked layers. Preferably, the height is ranged from 30 μm to 200 μm, or more than 200 μm.

Refer to FIG. 3C, which shows a top view of inkjet printed structures according to another embodiment of the present invention. The inkjet printed structures 221 comprise at least one first inkjet printed structure 221a and at least one second inkjet printed structure 221b, wherein a width of the first inkjet printed structure 221a is greater than that of the second inkjet printed structure 221b, and the width difference therebetween is more than 10 μm. The pattern layer 22 is made more finely by disposing the second inkjet printed structure 221b around the first inkjet printed structure 221a, wherein the width of the second inkjet printed structure 221b is less than that of the first inkjet printed structure 221a.

The first inkjet printed structure 221a and the second inkjet printed structure 221b can be arranged with each other in other ways. Referring to FIG. 3D shows a top view of inkjet printed structures according to another embodiment of the present invention. The second inkjet printed structure 221b is printed again in the same area after the inkjet printed structure 221a is firstly printed and solidified, so that the second inkjet printed structure 221b is formed on the first inkjet printed structure 221a and there will be a width variation of the inkjet printed structures 221 along the height thereof.

Referring to FIGS. 3A to 3D, the width or height of the inkjet printed structures 221 can be changed, and the inkjet printed structures 221 can be laterally connected or stacked to generate substantial 3D imaging effect and the tactility of rough surface.

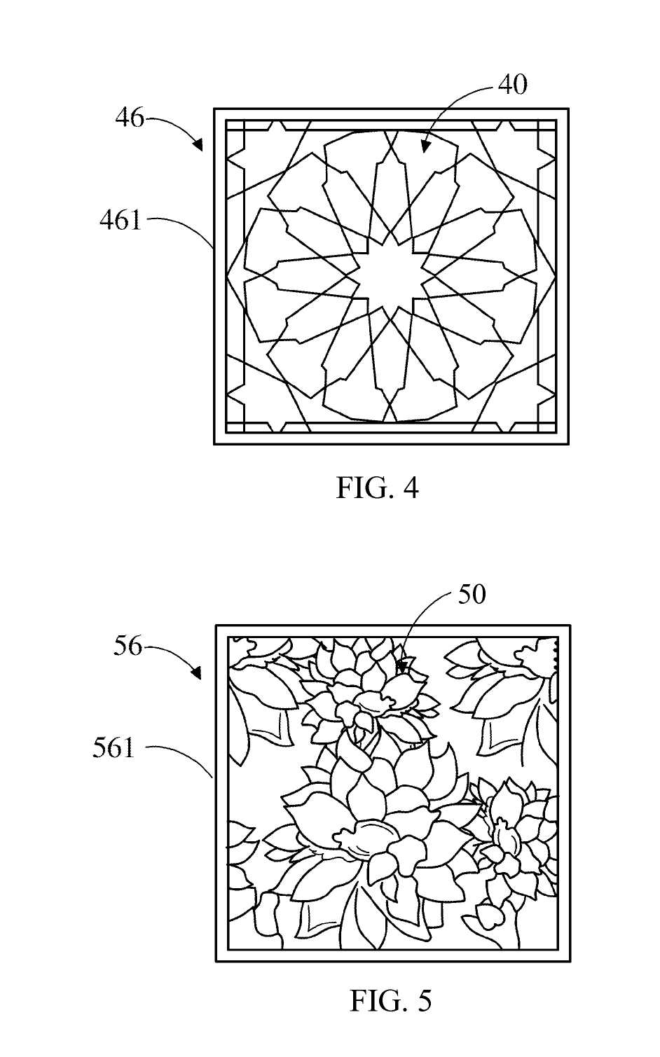

Refer to FIG. 4, which shows a schematic view of an illumination assembly installed in a light frame according to another embodiment of the present invention. A luminaire 46 has a light frame 461 and an illumination assembly 40. The illumination assembly 40 is applied to and installed in the light frame 461. The luminaire 46 can illuminate and provide predetermined aesthetic patterns; Meanwhile, the luminaire 46 can generate substantial 3D images as described above.

Refer to FIG. 5, which shows a schematic view of an illumination assembly installed in a drawing frame according to another embodiment of the present invention. A drawing (picture) 56 has a drawing frame 561 and an illumination assembly 50. The illumination assembly 50 is applied to and installed in the drawing frame 561. The drawing 56 can illuminate and provide predetermined aesthetic patterns. Meanwhile, the drawing 56 can generate substantial 3D images as described above.

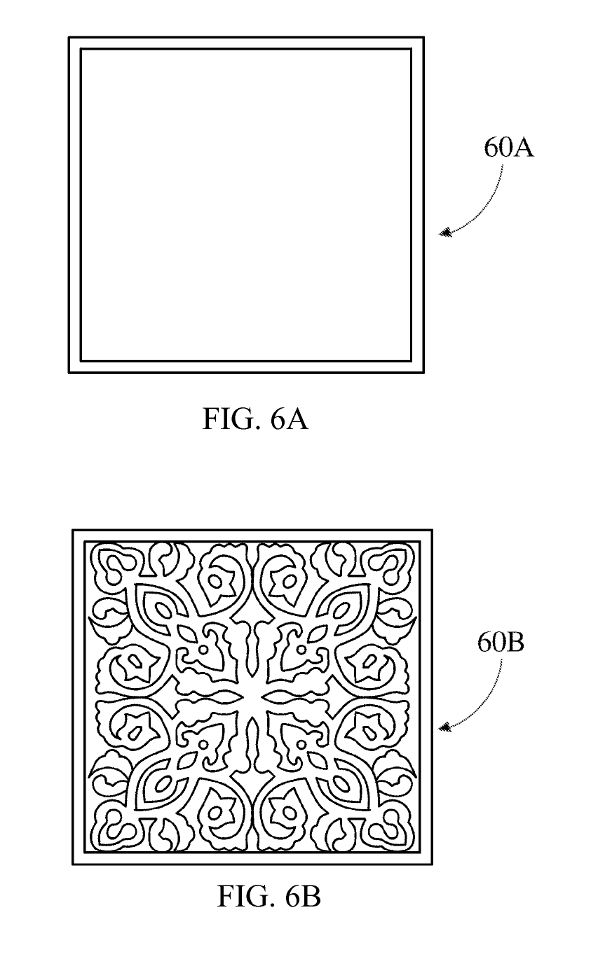

Refer to FIG. 6A and 6B, which show a schematic view of an illumination assembly according to an embodiment of the present invention when the light source does not emit light and a schematic view of an illumination assembly according to an embodiment of the present invention when the light source emits light. The illumination assembly 60A in FIG. 6A is used as a visible plate when the light source (not shown) does not emit light, i.e. light can pass through the illumination assembly 60A which thus has no shielding effect; and the illumination assembly 60B in FIG. 6B is used as a shielding plate when the light source emits light (not shown), i.e. light can not pass through the illumination assembly 60B which thus has a shielding effect. The illumination assembly 60A and the illumination assembly 60B can be used as partition or wall plates of a compartment. When it is unnecessary to provide a shielding effect, the illumination assembly 60A can be used as the partition or wall plates; when it is necessary to provide a shielding effect, the illumination assembly 60B can be used as the partition or wall plates. Furthermore, the illumination assembly 60A and the illumination assembly 60B can provide predetermined aesthetic patterns or generate substantial 3D images as described above.

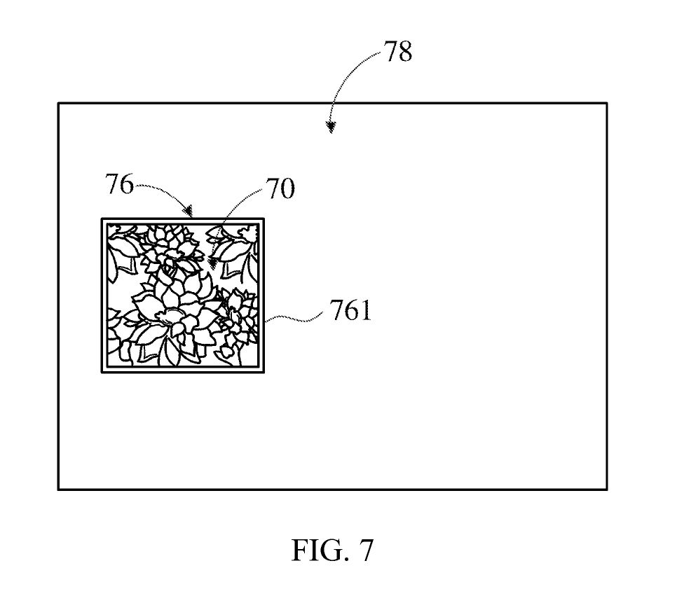

Refer to FIG. 7, which shows a schematic view of an illumination assembly installed in a window frame according to another embodiment of the present invention. A room 78 has a window 76. The window 76 has a window frame 761 and an illumination assembly 70. The illumination assembly 70 is applied to and installed in the window frame 761. The window 76 can illuminate and provide predetermined aesthetic patterns, or generate substantial 3D images as described above. Thus, the illumination assembly 70 of the window 76 can also be used as a visible plate as shown in FIG. 6A or a shielding plate as shown in FIG. 6B. When sunshine emits into the indoor through the window frame, the illumination assembly 70 does not need to illuminate, and thus can provide a pattern imaging effect and a shielding effect; if a user needs to strengthen the shielding effect of the illumination assembly 70, the illumination assembly 70 can further illuminate to further strengthen the shielding effect.

The pattern effect of the illumination assembly of the present invention can be produced and varied by adjusting the distribution density of the inkjet printed structures. The substantial 3D imaging effect and the tactility of rough surface can also be generated by laterally connecting and/or stacking the inkjet printed structures based on various arrangements. The higher the distribution density of the inkjet printed structures is (or the more the extent of laterally connecting and/or stacking thereof), the better the shielding effect of the inkjet printed structures generated by laterally connecting and/or stacking the inkjet printed structures will be. The width of each of the inkjet printed structures is ranged from 30 μm to 70 μm to form an excellent finely pattern, but the width is not limited thereto. All printed structures formed by inkjet printing can be used as the printed structures of the present invention.

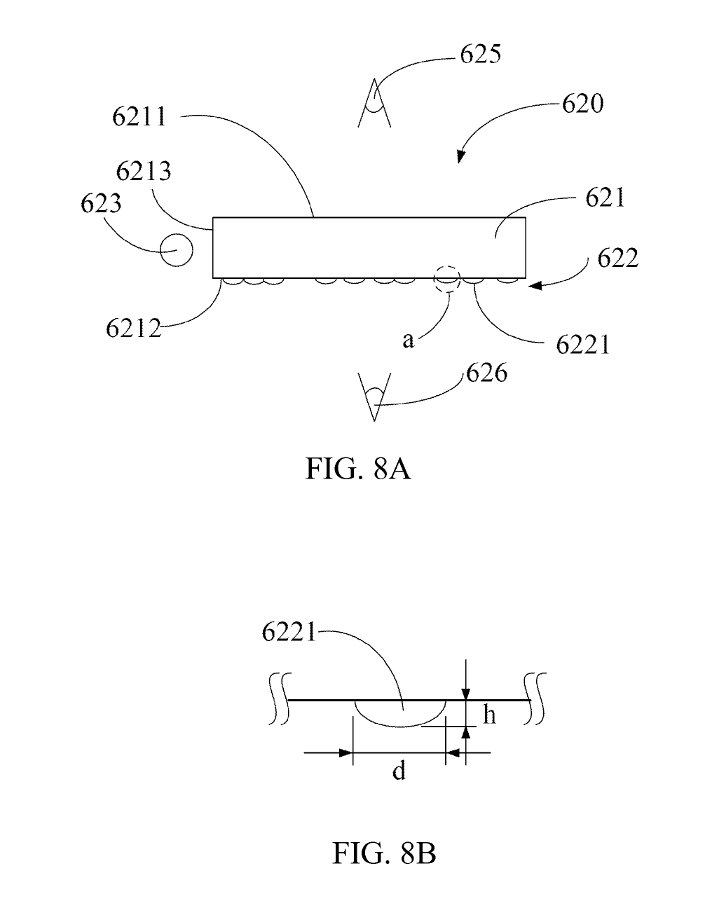

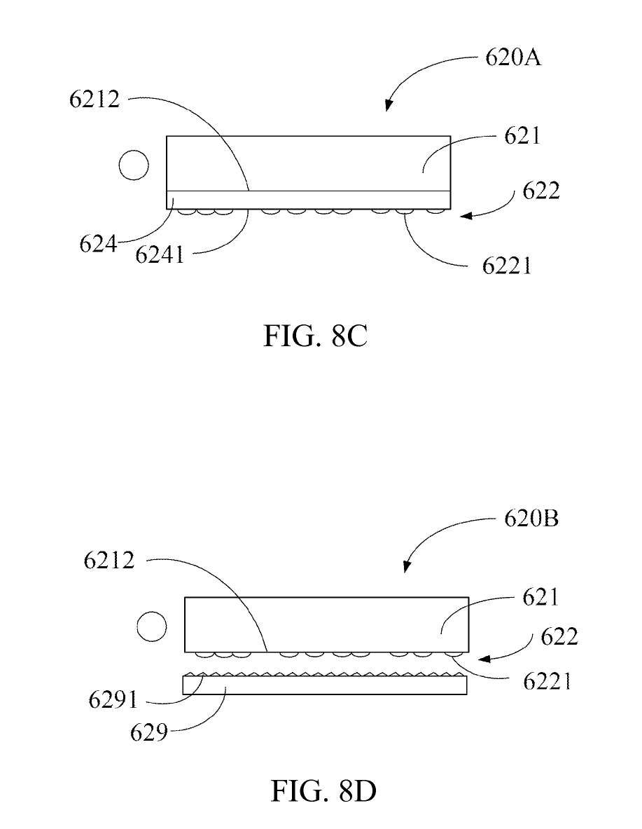

Refer to FIG. 8A, which shows a side view of an illumination assembly according to another embodiment of the present invention. The illumination assembly 620 of the present invention has an optical plate 621, a pattern layer 622, and a light source 623. The optical plate 621 has a first surface 6211 and a second surface 6212 opposite the first surface 6211. The pattern layer 622 is disposed on the second surface 6212. The light source 623 is disposed adjacent to the optical plate 621.

When the light source 623 is lighting, light is emitted outward from the first surface 6211 of the optical plate 621. If a user sees the optical plate 621 in front of the first surface 6211 along the first angle 625 in FIG. 8A, so that patterns on the pattern layer 622 can be seen and the optical plate 621 is used as a shielding plate; the optical plate 621 can be a shielding plate. Alternatively, if the user sees the optical plate 621 in front of the second surface 6212 along the second angle 626 in FIG. 8B, so that the optical plate 621 is used as a visible plate; the optical plate 621 can be a visible plate. In the embodiment, a ratio of the light extraction efficiency of the light emitted out of the first surface 6211 to that of the light emitted out of the second surface 6212 is ranged from 1.2 to 19.

The light is emitted out of the first surface 6211 by the pattern layer 622, so the pattern layer 622 can be shown clearly from the first surface 6211. Thus, the glare is obvious, and the optical plate 621 can be a shielding plate. Conversely, the light is emitted out of the second surface 6211 to a lesser extent. Thus the glare is not obvious, and the optical plate 621 can be seen clearly to be a visible plate.

Furthermore, light from the light source 623 can be reflected or refracted from the pattern layer 622 below the optical plate 621, and most of the light will emit out of the first surface 6211. When a user sees the optical plate 621 in front of the first surface 6211, patterns of the pattern layer 622 can be seen clearly. If the user sees the optical plate 621 in front of the first surface 6211 (or the second surface 6212), the shielding effect (or the visible effect) can be simultaneously provided. The reason is described as below: (1) most of light is emitted from the first surface 6211. When the user sees the optical plate 621 in front of the first surface 6211, there will be an apparent glare effect and the user cannot clearly see the object behind the optical plate 621, so as to provide the substantial shielding effect. Conversely, a few of the light is emitted from the second surface 6212. When the user sees the optical plate 621 in front of the second surface 6212, it has no an apparent glare effect and the user can clearly see the object behind the optical plate 621, so as to provide the substantial visible effect. (2) most of light is emitted from the first surface 6211, and a portion thereof is further reflected or refracted from the background or object (not-shown) in front of the first surface 6211 and then passed through the optical plate 621 to reach the outside of the second surface 6212. Thus, when a user sees the optical plate 621 from the second surface 6212, the background or object in front of the first surface 6211 can be clearly seen, so as to provide the substantial visible effect. Conversely, a few of the light is emitted from the second surface 6212, and a portion thereof is further reflected or refracted from the background or object (not-shown) in front of the second surface 6212 and then passed through the optical plate 621 to reach the outside of the first surface 6211. Thus, when the user sees the optical plate 621 from the first surface 6211, the background or object behind the second surface 6212 in front of the second surface 6212 cannot be seen, so as to provide the substantial shielding effect.

Referring to FIG. 8A, the optical plate 621 further comprises a side 6213 between the first surface 6211 and the second surface 6212, In the embodiment, the side 6213 is connected to the first surface 6211 and the second surface 6212. The optical plate 621 is made of transparent material which is poly methyl methacrylate (PMMA), polycarbonate (PC), cyclic olefin copolymer (COC), polystyrene (PS), or glass.

The light source 623 faces the side 6213, and the light 623 passes through the surface 5213 into the optical plate 621. The light source 623 is one or more light emitting diode (LED), or Cold Cathode Fluorescent Lamp (CCFL).

The pattern layer 622 has a plurality of microstructures 6221 which are protruded from the second surface 6212. Preferably, the microstructures 6221 are inkjet printed structures. The inkjet printed structures are directly formed by printing liquid inks or glue, or indirectly formed by firstly printing inks or glue and then by illuminating ultraviolet (UV) light or Infrared (IR) light, heating, cooling and embossing etc., but the forming method of the inkjet printed structures is not limited thereto. In alternative embodiments, the microstructures 6221 protruded from the second surface 6212 also can be formed by other processes, such as screen printing, glue dispensing, coating, stacking, 3D printing, micro-sintering or molding.

Refer to FIG. 8B, which shows a partial view of an area (a) from FIG. 8A. If the shape of microstructures 6221 of the pattern layer 622 are more arched, the light extraction from the first surface 6211 can be increased. When the shape of microstructures 6221 is changed, the light extraction from the first surface 6211 can be increased. In the embodiment, a ratio of the height (h) to the diameter (d) of each of the microstructures 6221 is preferably ranged from 1/7 to ⅓.

When the microstructures 6221 are inkjet printed structures, the arched shape can also be formed by the following way. Refer to FIG. 8C, which shows a side view of an illumination assembly according to another embodiment of the present invention. FIG. 8C is illustrated and similar to the illumination assembly according to FIG. 8A. As shown, the illumination assembly 620A further comprises an interface layer 624 disposed between the pattern layer 622 and the surface 6212 of the optical plate 621, and a surface tension of a surface 6241 of the interface layer 624 is smaller than that of the surface 6212. When the microstructures 6221 are formed on the surface 6241 of the interface layer 624, the microstructures 6221 will form an arched shaped because the surface tension of a surface 6241 of the interface layer 624 is relatively low. The interface layer 624 is made of acrylic material (such as methyl methacrylate or surface modifier), but not limited thereto.

Refer to FIG. 8D, which shows a side view of an illumination assembly according to another embodiment of the present invention. FIG. 8D is illustrated and similar to the illumination assembly according to FIG. 8A. As shown, the illumination assembly 620B further comprises a panel 629 disposed adjacent to the optical plate 621, wherein the panel 629 has at least one rough surface 6291, the rough surface 6291 is adjacent to and corresponding to the side 6212 of the optical plate 621. A portion of the light passing through the microstructures 6221 reflects or refracts from the rough surface 6291 and further emits out of the first surface 6211 (as shown in FIG. 8A); and a portion of the light which does not pass through the microstructures 6221 reflects or refracts from the microstructures 6221 and further emits out of the first surface 6211. Thus, substantial 3D images corresponding to patterns on the pattern layer 622 with offset or projection effect can be generated.

In another embodiment, the rough surface 6291 can also be not adjacent to and corresponding to the side 6212 of the optical plate 621. The rough surface 6291 can be disposed corresponding to the area which needs to show 3D images. The rough surface 6291 can be a curved surface, an arc surface, a hemispherical surface, or an embossed surface, but not limited thereto. Any rough surface having substantial 3D imaging effect can be used in the present invention.

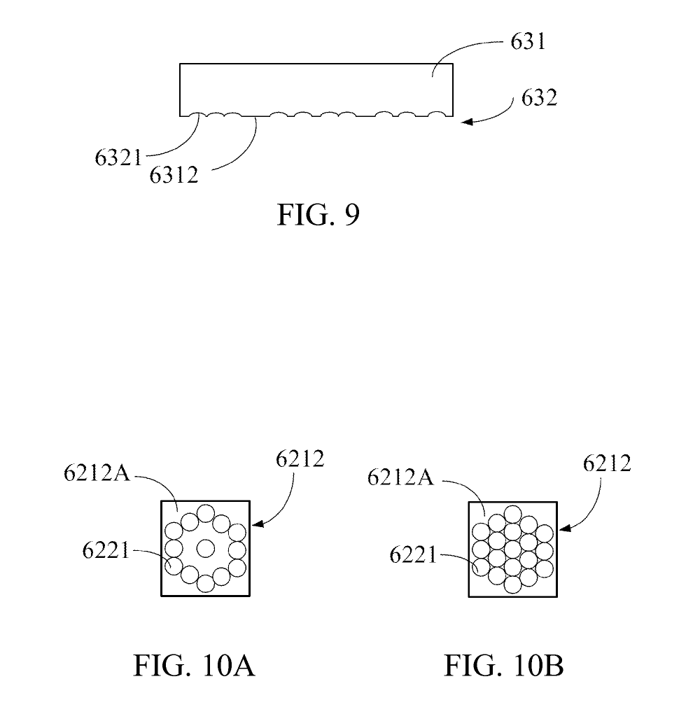

Refer to FIG. 9, which shows a side view of an optical plate according to another embodiment of the present invention. A pattern layer 632 is disposed on a second surface 6312 of the optical plate 631. The pattern layer 632 has a plurality of microstructures 6321. The microstructures 6321 are recessed in the second surface 6312. The microstructures 6321 are laser engraved structures. In another embodiment, the microstructures 6321 can be formed by etching, machining, or molding, but not limited thereto.

Referring to FIGS. 10A and 10B show schematic views of an optical plate disposed on the second surface from FIG. 8A. A second surface 6212 has a first area 6212A, a ratio of a total projected area of the microstructures disposed within the first area 6212A to a total area of the first area 6212A is greater than 0.1 (i.e. the shielding ratio is about greater than 0.1), so that the optical plate can provide the shielding effect and the visible effect. In the embodiment, a ratio of a total projected area of the microstructures disposed within the first area to a total area of the first area is ranged from 0.15 to 0.5, such that the shielding effect and the visible effect can be enhanced.

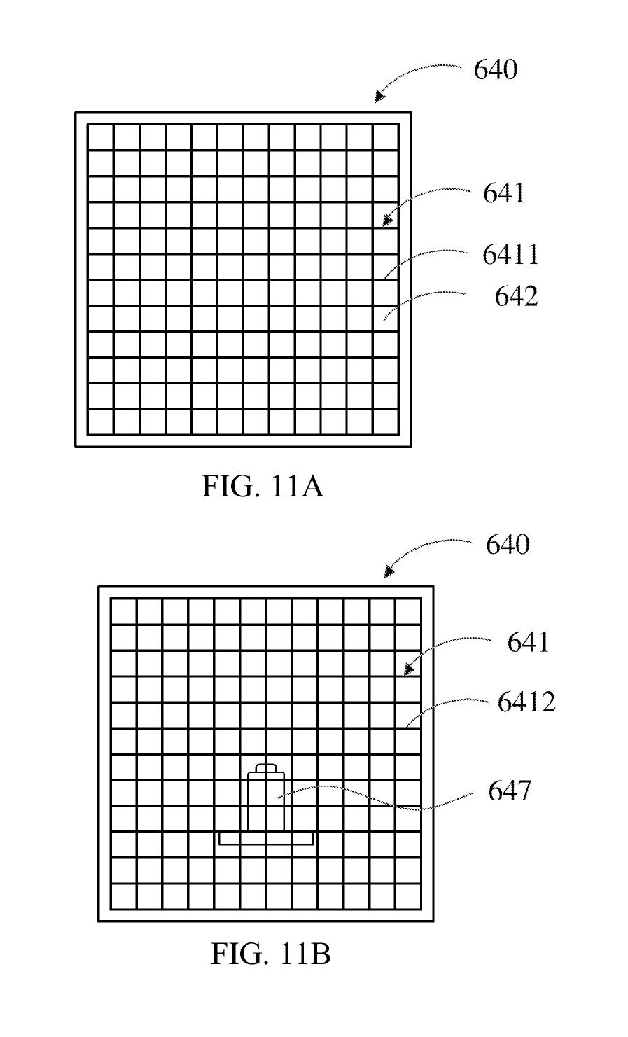

Refer to FIGS. 11A and 11B, which show schematic views of an illumination assembly; they are used as a shielding plate or a visible plate according to another embodiment of the present invention. When the light source lights of the illumination assembly 640, a user sees the optical plate 641 from the first surface 6411 in FIG. 11A, the optical plate 641 is used as a shielding plate, and the pattern layer 642 can be seen clearly, and the object behind the optical plate 641 cannot be seen. In addition, when the light source of the illumination assembly 640 does not emit the light, the user see the optical plate 641 from the second surface 6412 in FIG. 11B, the optical plate 641 is used as a visible plate, and the object behind the optical plate 641 can be seen. In the embodiment, a bottle behind the optical plate 641 can be seen.

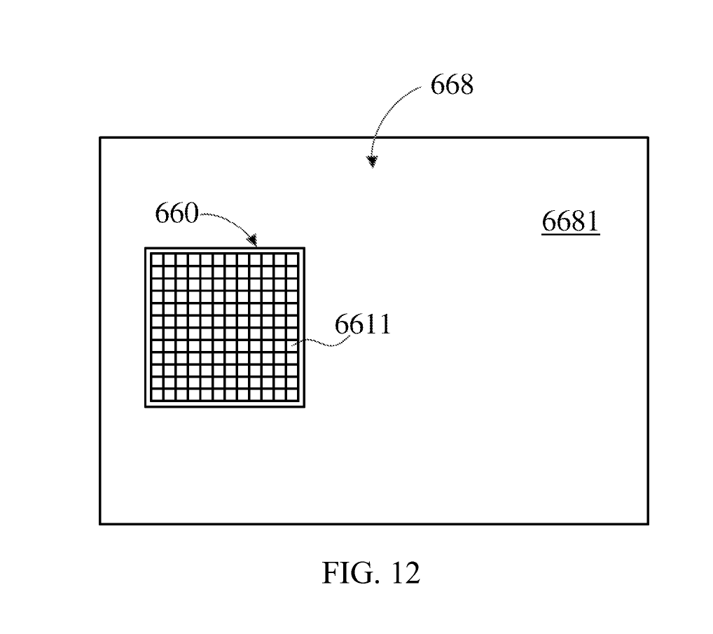

Refer to FIG. 12, which shows a schematic view of an illumination assembly disposed in a compartment. An illumination assembly 660 is disposed near a periphery 6681 of a compartment 668, wherein the first surface 6611 faces outside of the compartment 668, and the second surface faces inside of the compartment 668. In the embodiment, the compartment 668 is a conference room, and the illumination assembly 660 is a window assembly. The compartment 668 is perspective by seeing from inside or outside when the light source of the illumination assembly 660 does not emit the light. When the conference room is not used, the illumination assembly 660 does not need to illuminate, and thus the outside of the compartment 668 can be seen from the inside through the illumination assembly 660 which allows light to pass therethrough; and when the conference room is used, the illumination assembly 660 illuminates, the outside of the compartment 668 can still be seen from the inside through the illumination assembly 660. But, the inside of the compartment 668 cannot be seen from the outside, and only patterns on the illumination assembly 660 can be seen from the outside.

In another embodiment, the compartment can also be a bedroom or a bathroom. The periphery of the compartment is a wall, a part of a wall, a window assembly, or a part of a window assembly. The first surface 6611 also can face inside of the compartment 668, and the second surface can faces outside of the compartment 668.

The arrangement of the compartment, the periphery, the first and second surfaces is not limited to the foregoing embodiments. Only if an illumination assembly is disposed on a location to illuminate and the first and second surfaces can provide substantial shielding and visible effects, the illumination assembly can be used in the present invention.

The present invention has been described with a preferred embodiment thereof and it is understood that many changes and modifications to the described embodiment can be carried out without departing from the scope and the spirit of the invention that is intended to be limited only by the appended claims.

What is claimed is:

1. An illumination assembly, comprising:
an optical plate made of transparent material and having a surface and at least one side connected to the surface;
a pattern layer disposed on the surface and having a plurality of microstructures; and
a light source disposed adjacent to the optical plate.

2. The illumination assembly according to claim 1, wherein the light source is an LED or a lamp, and disposed adjacent to and corresponding to the side of the optical plate.

3. The illumination assembly according to claim 1, wherein the illumination assembly further comprises an interface layer disposed between the pattern layer and the surface of the optical plate, and a surface tension of the interface layer is less than that of the surface.

4. The illumination assembly according to claim 1, wherein the microstructures are inkjet printed structures.

5. The illumination assembly according to claim 4, wherein the inkjet printed structures are laterally connected to each other, so as to form a broad structural area.

6. The illumination assembly according to claim 4, wherein the inkjet printed structures are stacked with each other, so as to form a stacked structural area.

7. The illumination assembly according to claim 4, wherein the inkjet printed structures comprise at least one first inkjet printed structure and at least one second inkjet printed structure, a width of the first inkjet printed structure is greater than that of the second inkjet printed structure, and the difference therebetween is more than 10 um.

8. The illumination assembly according to claim 1, wherein the illumination assembly is installed in a light frame, a drawing frame, or a window frame.

9. The illumination assembly according to claim 1, wherein the illumination assembly is a visible plate when the light source does not emit light, and the illumination assembly is a shielding plate when the light source emits light.

10. An illumination assembly, comprising:
an optical plate having a first surface and a second surface opposite the first surface;
a pattern layer disposed on the second surface and having a plurality of microstructures; and
a light source disposed adjacent to the optical plate and emitting light into the optical plate, wherein the light is further emitted out of the optical plate from the first surface;
wherein the optical plate is used as a shielding plate if the optical plate is viewed from the first surface, and the optical plate is used as a visible plate if the optical plate is viewed from the second surface.

11. The illumination assembly according to claim 10, wherein the optical plate further comprises a side between the first surface and the second surface, and the light source faces the side.

12. The illumination assembly according to claim 10, wherein the microstructures are protruded from or recessed in the second surface.

13. The illumination assembly according to claim 10, wherein the microstructures are inkjet printed structures, screen printed structures, or laser engraved structures.

14. The illumination assembly according to claim 10, wherein a ratio of the height to the diameter of each of the microstructures is ranged from 1/7 to ⅓.

15. The illumination assembly according to claim 10, wherein the second surface has a first area, and a ratio of a total projected area of the microstructures disposed within the first area to a total area of the first area is ranged from 0.15 to 0.5.

16. The illumination assembly according to claim 10, wherein the illumination assembly is disposed in a compartment.

17. The illumination assembly according to claim 16, wherein the first surface faces outside of the compartment, and the second surface faces inside of the compartment.

18. The illumination assembly according to claim 16, wherein the compartment is a bedroom, a conference room, or a bathroom.

19. The illumination assembly according to claim 10, wherein a ratio of the light extraction efficiency of the light emitted out of the first surface to that of the light emitted out of the second surface is ranged from 1.2 to 19.

20. The illumination assembly according to claim 10, wherein the illumination assembly further comprises:
a panel disposed adjacent to the optical plate, wherein the panel has at least one rough surface, and the light passes through the rough surface to generate substantial 3D images corresponding to the pattern layer.
